(19) United States
(12) Patent Application Publication
(10) Pub. No.: US 2008/0165164 A1
(43) Pub. Date: Jul. 10, 2008

(54) DEVICE, APPARATUS, METHOD, AND COMPUTER PROGRAM FOR AN INPUT INTERFACE

(75) Inventor: Heli Tuulos, Helsinki (FI)

Correspondence Address: PERMAN & GREEN, 425 POST ROAD, FAIRFIELD, CT, 06824, US

(73) Assignee: NOKIA CORPORATION, Espoo (FI)

(21) Appl. No.: 11/621,268

(22) Filed: Jan. 9, 2007

(51) Int. Cl. G06F 3/033

(52) U.S. Cl. 345/184

(57) ABSTRACT

A device is disclosed, including a first rotator being associated with a first set of functionalities for selection and a second rotator being associated with a second set of functionalities for selection. A corresponding apparatus and method is also disclosed. Further, a computer program product for implementing the method is disclosed.

### FIELD

The disclosed embodiments relates to a device comprising rotators, an apparatus comprising such a device, an input method, and a computer product comprising instructions for carrying out said method.

### BACKGROUND

Mobile devices such as mobile telephones, personal digital assistants, portable media players etc. generally have user interfaces containing user input keys. Since mobile devices tend to get smaller and smaller and the display area at the same time is getting larger, the surface area on which the input means are located is limited. The main purpose of the keypad is character input, but it is also used for menu navigation, control and selection of items on the screen. Attempts have been made to provide user-friendly space efficient alternatives to the traditional keybased input means. Examples are scroll wheels, jog dials, track balls, disc dials, etc. EP1538513A1 discloses an input device comprising a multidirectional input device for the purpose of inputting character data and option choice information. Although these types of input interfaces are user friendly they still require a large amount of key presses for character input. As the mobile devices of today become more and more complex, there is an increasing need for multifunctional input methods, which at the same time do not loose the simplicity and intuitiveness of the input interface.

### SUMMARY

In view of the above, it would be advantageous to solve or at least reduce the problems discussed above. In particular, it would be advantageous to provide a user friendly input interface for inputting data and controlling applications in an apparatus.

The disclosed embodiments are based on the understanding that an apparatus, e.g. a mobile communication apparatus, may comprise a plurality of rotators, where each rotator is controlling different aspects or is having different functionalities of the apparatus.

A particular advantage of the disclosed embodiments is that the plurality of rotators, which are adapted for controlling different functionalities respectively, are providing a user friendly input interface which may reduce the number of key presses and increase the number of directly selectable options.

A particular feature of an embodiment relates to using a first rotator to select applications, navigate menus, erase inputted symbols etc. and at least one other rotator for symbol/character input. The user will then experience easier handling of the apparatus. Further the complexity of the input interface is much smaller compared to e.g. a standard keypad. E.g. by having one rotator that can be used to open and control applications and to change operation modes, and at the same time having another rotator that can be used to input parameters, scrolling, select sub-functions, etc., the input interface is streamlined and thus more intuitive.

According to a first aspect of the disclosed embodiments, there is provided a device comprising a first rotator being associated with a first set of functionalities for selection and a second rotator being associated with a second set of functionalities for selection. The second set of functionalities may dynamically depend on a selection of the first set of functionalities, or the selection of the first and second sets of functionalities may be independent.

The first set of functionalities may comprise a set of applications and the second set of functionalities may comprise another set of applications, or the first and second sets of functionalities may comprise a set of applications, which then may be common for the sets.

The device may be arranged to provide input of a first category relating to the first set of functionalities from the first rotator and to provide input of a second category relating to the second set of functionalities from the second rotator.

In the device, the first and second rotator may be any of a scroll wheel, a pressable scroll wheel, a multidirectional joystick, a jog dial, a jog wheel, a track ball or a disc dial. The first or second rotator may be arranged to be movable in a fixed number of positions, and wherein each position is associated with input data of an input category. Both rotators may be arranged in this way. Further, the first or second rotators may also be arranged to provide a rotatable movement around at least one rotation axis, the rotatable movement generating signals associated with input of a category. Again this may apply to both rotators.

This can be used to improve a user interface as different functionalities can be controlled via different rotators. For example, each rotator may be a scroll wheel containing ten different positions. The first rotator may have input symbols for menu, erasing, text input, caps lock and “soft symbols” (symbols that the user can set to be shortcuts to applications etc.) The second rotator may have input symbols for the numbers 0 to 9 and the letters of the English alphabet, for example one number and three letters per position (e.g. 0/A/B/C).

The device according to the first aspect of the disclosed embodiments may further comprise at least one other rotator. This may further improve the user interface with the possibility of distributing the input symbols over several rotators, for example a first rotator may have symbols as described above and a second rotator may have symbols for the numbers 0 to 9, while a third and a fourth rotator may contain the letters of the English alphabet, for example like this: the third rotator containing the consonants, two letters per position of the interface (e.g. B/C) and the fourth rotator containing the vowels along with a period, comma, hyphen, and space.

According to a second aspect of the disclosed embodiments, there is provided an apparatus comprising a processor and a user interface, the user interface comprising a display and an input interface, the input interface comprising a first rotator being associated with a first set of functionalities for selection handled by the processor and a second rotator for selection being associated with a second set of functionalities handled by the processor.

The second set of functionalities may dynamically depend on a selection of the first set of functionalities, or the selection of the first and second sets of functionalities may be independent.

The first set of functionalities may comprise a set of applications and the second set of functionalities may comprise another set of applications, or the first and second sets of functionalities may comprise one set of applications.

The input interface may be arranged to provide input of a first category relating to the first set of functionalities from the first rotator and to provide input of a second category relating to the second set of functionalities from the second rotator.

The first rotator may be adapted for input of the input of the first category, the input being adapted for control of the first set of functionalities. The input may be any of the group comprising: menu navigation input, application control input, application select input, and parameter input. The second rotator may be adapted for input of the input of the second category, the input being adapted for parameter input relating to the second set of functionalities. The input may be any of the group comprising: letters, numerals, special characters, and other symbols.

The first set of functionalities may be any of the group comprising: menu navigation, application control, application selection, and parameter data input.

The second set of functionalities may be any of the group comprising: character input, numeral input, letter input, and symbol input.

Any of the first and second rotators may be any of a scroll wheel, a pressable scroll wheel, a multidirectional joystick, a jog dial, a jog wheel, a track ball or a disc dial.

The first or second rotator may be arranged to be movable in a fixed number of positions, each position being associated with input data of an input category. Both of the rotators may be arranged in this way. The first or second rotator may further be arranged to provide a rotatable movement around at least one rotation axis, the rotatable movement generating signals associated with input of a category. Again, this may apply to both of the rotators.

The input interface of the apparatus according to the second aspect of the disclosed embodiments may further comprise at least one other rotator.

The apparatus may comprise a mobile telephone, a personal digital assistant, a portable media player, a digital camera, a remote control device, a cordless telephone, a game console, a videophone, or any combination thereof.

According to a third aspect of the disclosed embodiments, there is provided a method comprising:

receiving input from a first rotator associated with a first set of functionalities;

receiving input from a second rotator associated with a second set of functionalities; and

enabling selection of a functionality based on any of the inputs.

The method may further comprise:

generating a first signal associated with the first rotator;

generating a second signal associated with the second rotator; and

transmitting the first and second signals to a processor.

The method may further comprise:

determining, in the processor, a first processing action depending on the first signal, the first processing action being associated with the first set of functionalities;

executing the first processing action in the processor.

The method may further comprise:

determining, in the processor, a second processing action depending on the second signal, the second processing action being associated with the second set of functionalities;

executing the second processing action in the processor.

The method may further be carried out according to an order adapted according to the events generated by the current user interactions and the at the present moment received input.

The method may further comprise determining the second set of functionalities based on a performed selection of the first set of functionalities.

According to a fourth aspect, there is provided a computer product comprising instructions for performing the method according to the third aspect of the disclosed embodiments.

The instructions comprised in the computer product may further be carried out according to an order adapted according to the events generated by the current user interactions and the at a present moment received input data.

The computer program may further be executed on an apparatus according to the second aspect of the disclosed embodiments, especially executed by the processor of the apparatus.

The computer program may further incorporate any features described with reference to the apparatus according to the second aspect of the disclosed embodiments and with reference to the method according to the third aspect of the disclosed embodiments.

The computer program product may be a computer-readable medium having the computer-executable components, i.e. one or more computer programs.

In this context, i.e. for the first to fourth aspect of the disclosed embodiments, a rotator should be construed as a rotator means. Thus the term rotator is equivalent to the term rotator means, which may be equivalent to any of the group comprising a scroll wheel, a pressable scroll wheel, a multidirectional joystick, a jog dial, a jog wheel, a track ball and a disc dial.

Other features and advantages of the disclosed embodiments will appear from the following detailed disclosure, from the attached dependent claims as well as from the drawings.

### BRIEF DESCRIPTION OF THE DRAWINGS

The above, as well as additional features and advantages of the disclosed embodiments, will best be understood through the following illustrative and non-limiting detailed description of preferred embodiments, with reference to the appended drawings, where the same reference numerals will be used for similar elements, wherein:

FIG. 1 is a schematic illustration of a device comprising two rotators;

FIG. 2 illustrates a mobile communication apparatus comprising two rotators;

FIG. 3 illustrates a mobile communication apparatus comprising two rotators and a keypad;

FIG. 4 illustrates a mobile communication apparatus comprising three rotators;

FIG. 5 illustrates a mobile communication apparatus comprising four rotators;

FIG. 6 is a schematic illustration of an example of the representation of the input symbols for two rotators;

FIG. 7 is a schematic illustration of an example of the representation of the input symbols for three rotators;

FIG. 8 is a schematic illustration of an example of the representation of the input symbols for four rotators;

FIG. 9 is a schematic illustration of a method according to an embodiment of the invention;

FIG. 10 is a schematic illustration of a method according to an embodiment of the invention;

FIG. 11 illustrates a mobile communication apparatus, comprising two rotators, to which apparatus is attached a device, comprising at least one rotator; and

FIG. 12 illustrates a mobile communication apparatus comprising two rotators.

### DETAILED DESCRIPTION

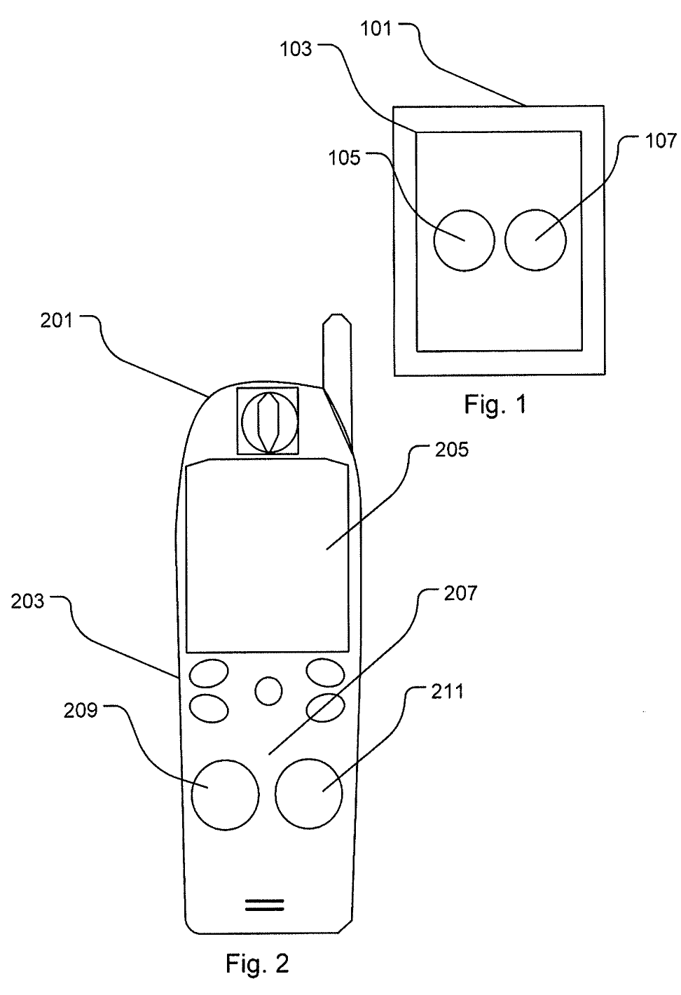

FIG. 1 is a schematic view of a device 101 according to an embodiment comprising a first rotator 105 being associated with a first set of functionalities and a second rotator 107 being associated with a second set of functionalities, and said module 101 is arranged to provide data of a first category relating to said first set of functionalities from said first rotator 105 and to provide data of a second category relating to said second set of functionalities from said second rotator 107. The device 101 can according to an embodiment be contained in a mobile communication apparatus. Other possibilities can be to apply the module as a separate user interface on another mobile device, for example on a portable media player or as a remote control for such a device. The device 101 can further comprise at least one other rotator. The rotator described above is equivalent to a rotator means.

FIG. 2 shows a mobile communication apparatus 201 according to an embodiment comprising a processor (not shown) and a user interface 203 comprising a display 205 and an input interface 207. The input interface 207 further comprises a first rotator 209 and a second rotator 211.

The first and second rotators are equivalent to rotator means and can be a scroll wheel, a pressable scroll wheel, a multidirectional joystick, a jog dial, a jog wheel, a track ball or a disc dial etc. The mobile communication apparatus can also comprise other elements normally present in such an apparatus, such as a keypad, a speaker, a microphone, a memory (not shown), etc. The first rotator can be associated with a first set of functionalities handled by the processor. Examples of such functionalities are menu navigation, application control, application selection and parameter input. At the same time the second rotator can be associated with a second set of functionalities also handled by the processor. Examples of such functionalities are input of characters, numerals, letters and symbols. Further the processor is adapted to handle data of a first category relating to said first set of functionalities from said first rotator 209 and to handle data of a second category relating to said second set of functionalities from said second rotator 211. This means that the processor in the mobile communication apparatus can handle the input data coming from the first rotator 209 and treating it as data related to the first set of functionalities and to simultaneously handle the input data coming from the second rotator 211 and treating it as data related to the second set of functionalities. The handling of data can take place according to a changing process that adapts itself to the data input by the user via the first and second rotators 209, 211. Thus, the first rotator can be adapted to input data of the first category, the data being adapted for control of said first set of functionalities. The data of the first category can for example be menu navigation data, application control data, application select data, and parameter input data. Similarly, the second rotator can be adapted to input data of the second category, the data being adapted for parameter input relating to said second set of functionalities. The data of the second category can for example be letters, numerals, special characters, and other symbols. Further, the first rotator can be arranged to either be movable in a fixed number of positions, where each position is associated with input data of said first category or to provide a rotatable movement generating signal associated with input data of said first category. The same can apply to the second rotator. The mobile communication apparatus 201 can for example comprise a mobile telephone, a personal digital assistant, a portable media player, a digital camera, a remote control device, a cordless phone, a game console, a videophone, or any combination thereof. The input interface 207 can further comprise at least one other rotator. The number of rotators can be chosen in any way that is appropriate for the desired capability of the mobile communication apparatus.

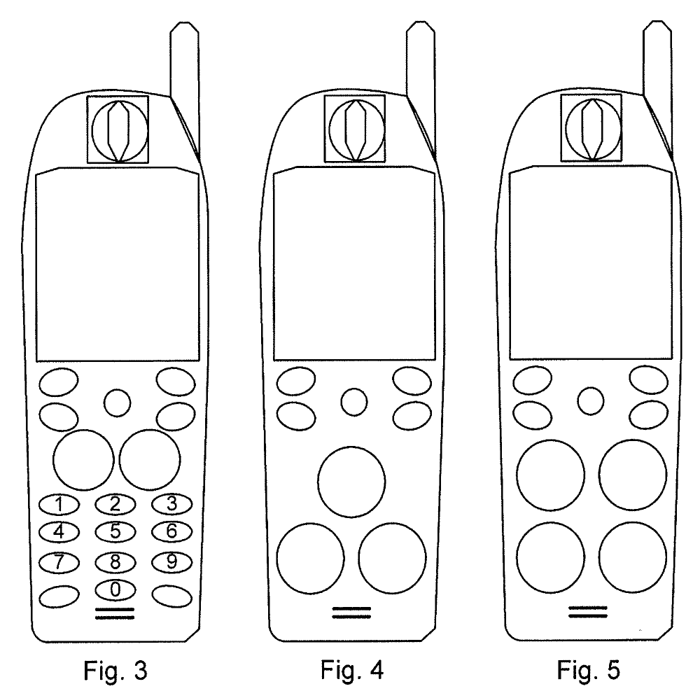

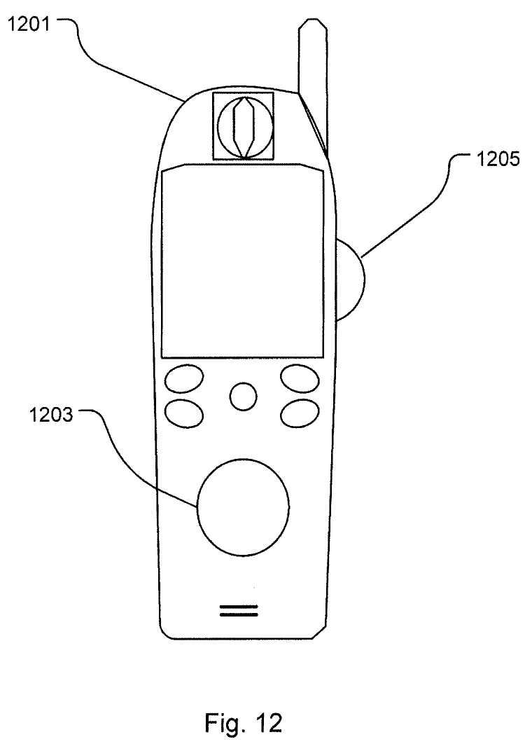

The embodiments described below, with reference to FIG. 3-5, are mainly examples of possible ways of implementing rotators on an input interface. The apparatus can of course have a completely different appearance, where the rotators can be placed for example on the side of the apparatus, as is illustrated in FIG. 12. The detailed description above with reference to FIG. 2 also applies to the below following embodiments described with reference to FIG. 3-5.

FIG. 3 illustrates a mobile communication apparatus comprising two rotators and a keypad. In this embodiment it can be desirable to, in addition to the two rotators, provide a traditional keypad for increased possibilities and more flexibility regarding control of user input functions.

FIG. 4 illustrates a mobile communication apparatus comprising three rotators. Each of the rotators is associated with a set of functionalities, respectively.

FIG. 5 illustrates a mobile communication apparatus comprising four rotators. Each of the rotators is associated with a set of functionalities, respectively.

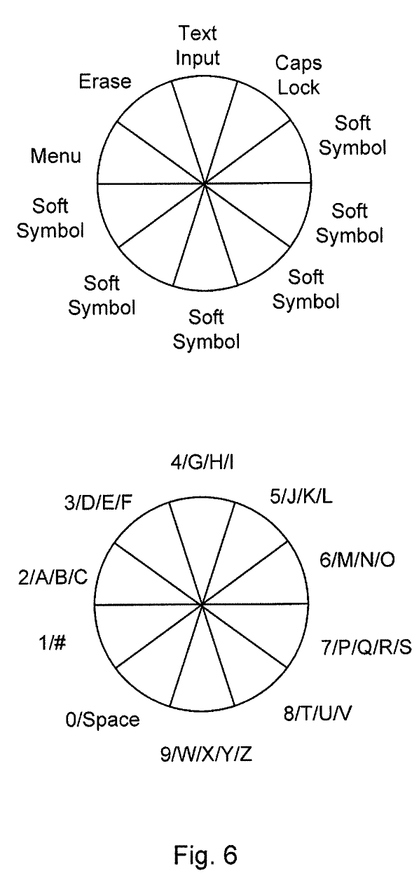

FIG. 6 illustrates an example of a possible symbol representation of the fixed positions of a rotator for an embodiment comprising two rotators. In this example each rotator can contain ten different symbols. The first rotator can have one symbol for menu, one symbol for erasing, one symbol for text input, one symbol for caps lock, and “soft symbols” (symbols that the user can set to be shortcuts to applications etc.). The second rotator can contain the numbers from 0 to 9 and the letters of the English alphabet in groups of three or four and symbols for space and #.

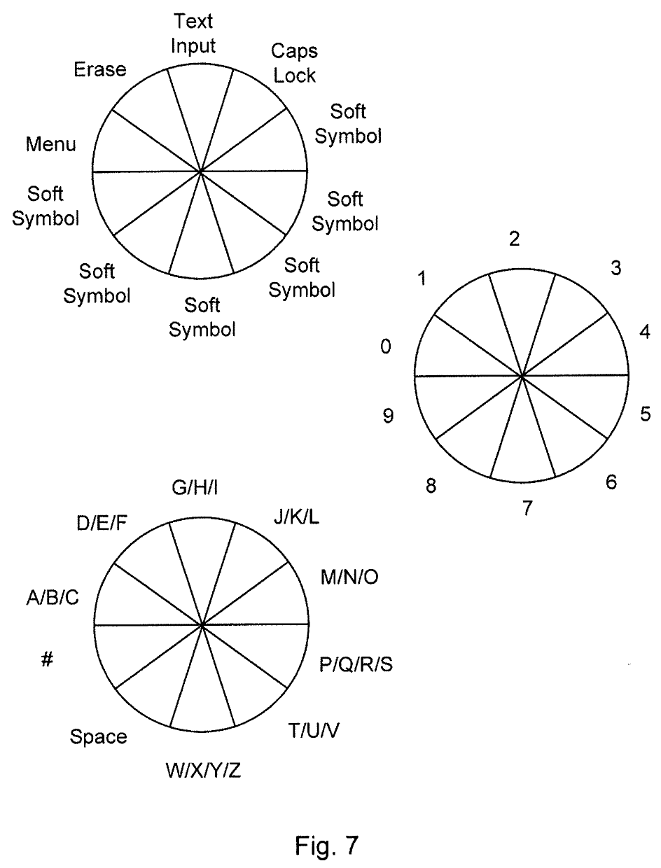

FIG. 7 illustrates an example of a possible symbol representation of the fixed positions of a rotator for another embodiment comprising three rotators. Each rotator can contain ten different symbols. The first rotator can have symbols for menu, erasing, etc. as described in the example in FIG. 6. The second rotator can contain the numbers from 0 to 9. The third rotator can contain the letters of the English alphabet in groups of three or four and symbols for space and #.

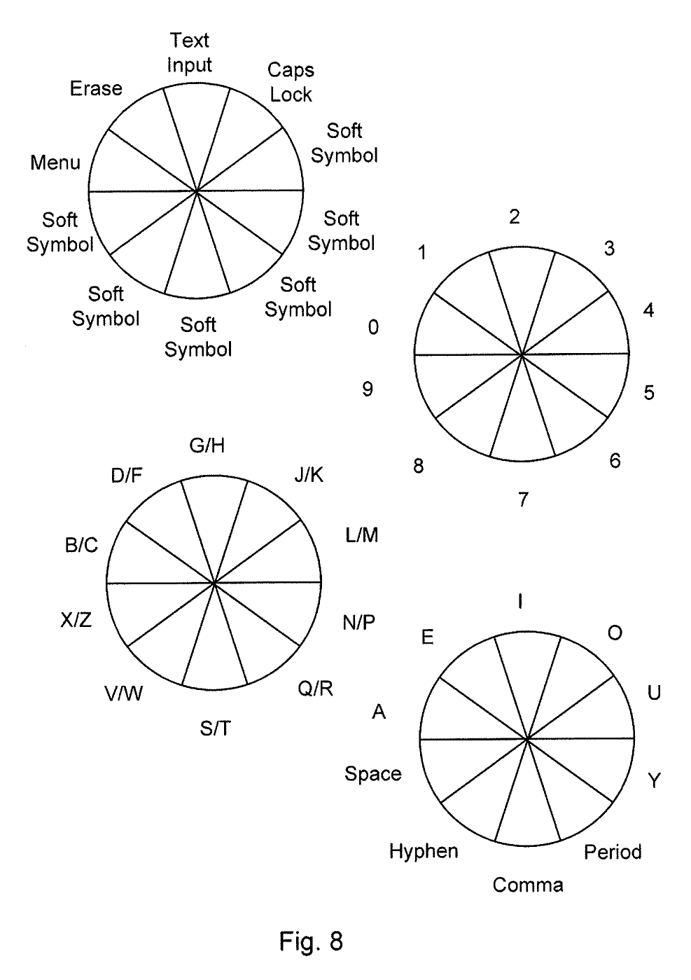

FIG. 8 illustrates an example of a possible symbol representation of the fixed positions of a rotator for yet another embodiment comprising four rotators. Each rotator can contain ten different symbols. The first rotator can have symbols for menu, erasing, etc. as described in the previous examples. The second rotator can contain the numbers from 0 to 9. The third rotator can contain the consonants, two letters per each position (e.g. B/C) and the fourth rotator can contain the vowels along with a period, comma, hyphen and space.

The embodiments described above with reference to FIG. 6-8 are examples of possible ways of representing symbols on a rotator. The number of fixed positions can be different and the distribution of symbols can be done in many ways, which is enabled by the disclosed embodiments.

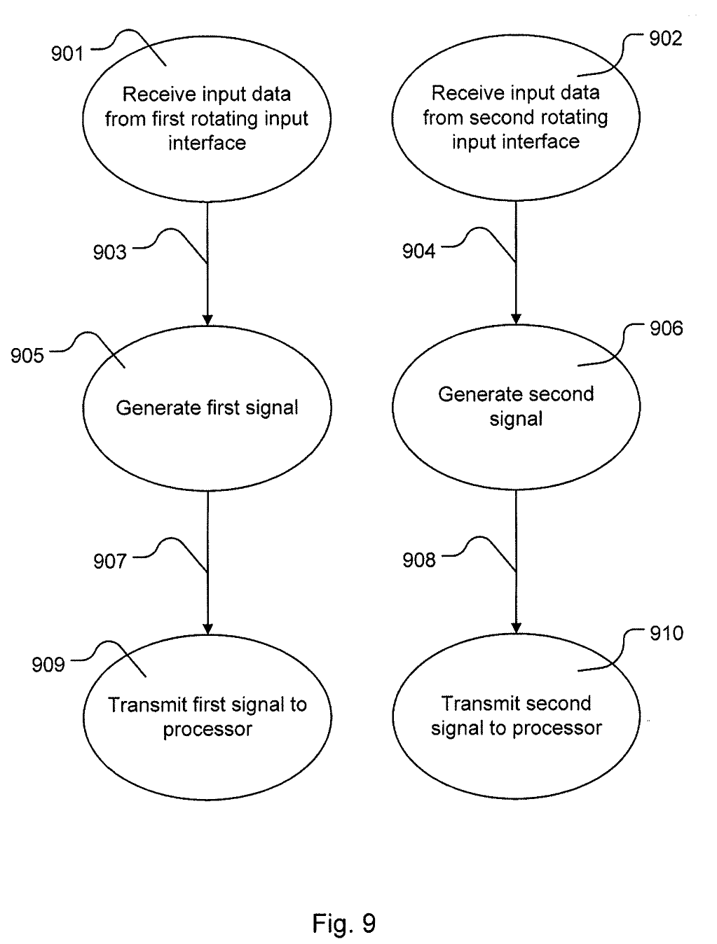

FIG. 9 illustrates a method for inputting data according to an embodiment comprising receiving 901 input data of a first category from a first rotator and receiving 902 input data of a second category from a second rotator. The received input data of the first category 903 is associated with a first set of functionalities and is used to generate 905 a first signal 907 and the received input data of the second category 904 is associated with a second set of functionalities and is used to generate 906 a second signal 908. The first signal 907 is transmitted 909 to a processor and the second signal 908 is also transmitted 910 to the same processor. An example of a possible course of events is described in the following. The user can be using the first rotator to select an application. The input data received from the first rotator is then generating a signal which is transmitted to the processor where a processing action is determined which is then executed in the processor. The next event can be that the user is using the second rotator to enter one or many symbols. The symbol input generates another signal, which is transmitted to the processor where another processing action is determined and executed. The symbol input can continue through the second rotator or the user might decide to use the first rotator again to select another application or to navigate menus. The signals and processing actions can be generated according to the random events initiated by the user of the mobile communication apparatus. This process is an ever-changing row of events controlled by how the user chooses to interact with and how to use the two rotators.

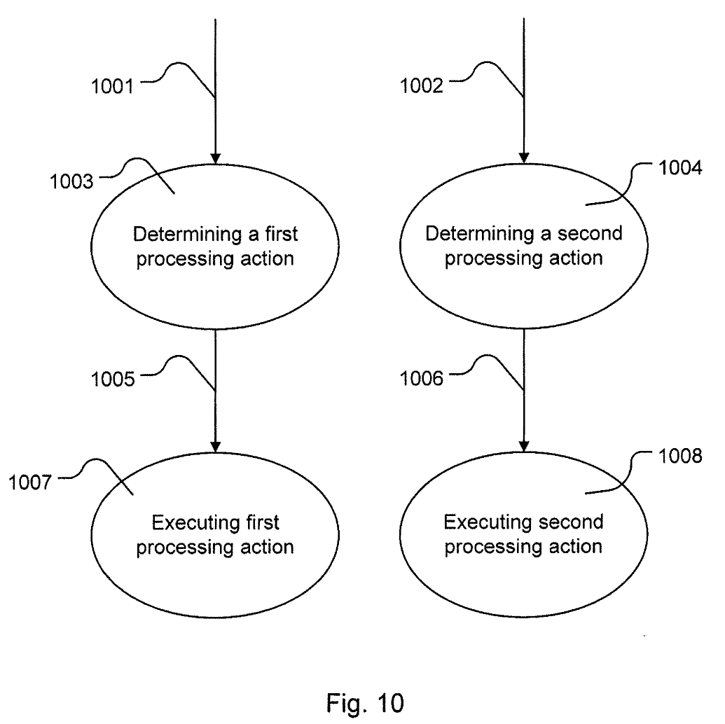

FIG. 10 illustrates a method in a processor according to an embodiment comprising determining 1003 a first processing action 1005 depending on the first signal 1001 transmitted to the processor in the method in FIG. 9 and executing 1007 the first processing action and determining 1004 a second processing action 1006 depending on the second signal 1002 transmitted to the processor in the method in FIG. 9 and executing 1008 the second processing action. The actions in the method in FIG. 10 are of course generated accordingly with the course of events taking place in the method described in FIG. 9. For example when a user is using the first and second rotator in a random order, this generates the corresponding processing actions and their respective execution in the processor.

Another example of a possible course of events is that the processor, depending on the processing actions executed, via the display returns new options or choices to be made by the user through the first and/or the second rotator.

As an example, the rotators could also be spaced apart on the apparatus. This would signal their different sets of functionalities and could be done by placing them close to other components of the apparatus having different functionalities or in a position comfortable or intuitive for use with the components associated with that functionality.

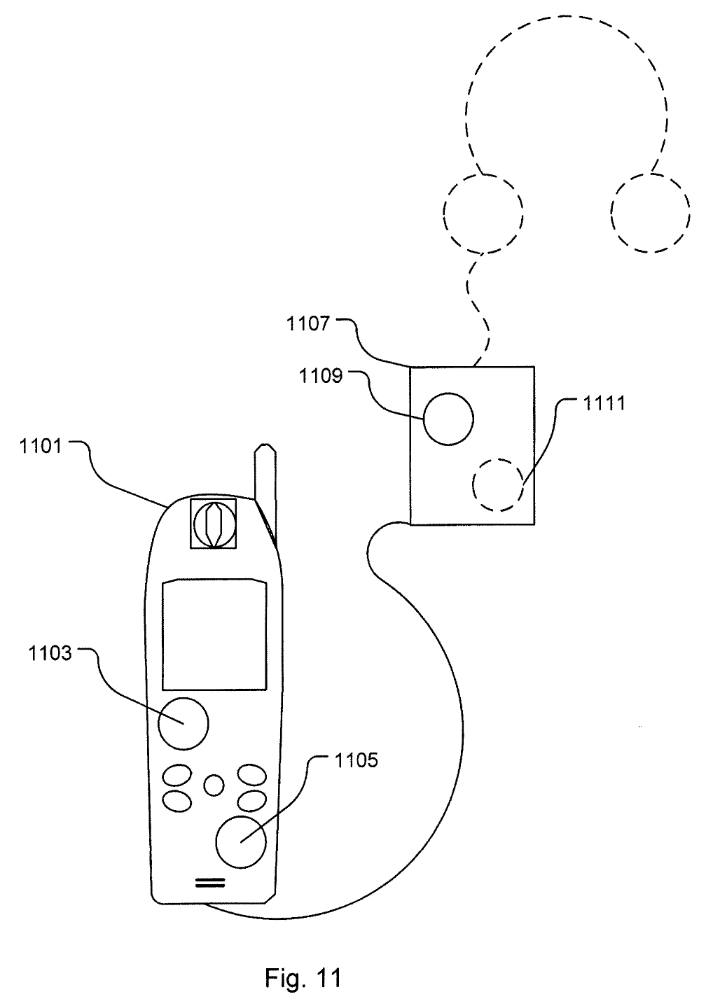

FIG. 11 illustrates a mobile communication apparatus 1101 comprising a first and a second rotator 1103, 1105 located in positions that are spaced apart. The first and second rotator 1103, 1105 can be of different types and associated with different functionalities, as referred to earlier. To the mobile communication apparatus is attached, via a cable or a wireless connection, a device 1107 comprising a third rotator 1109, said device acting as a remote control adapted to control applications in said mobile communication apparatus. The third rotator can be associated with a third functionality or be associated with any of the first or second functionalities. In addition, said device could comprise a fourth rotator 1111 associated with a fourth functionality or similarly associated with any of the first or second functionalities.

FIG. 12 illustrates a mobile communication apparatus 1201 comprising a first and a second rotator 1203, 1205. The first and second rotators 1203, 1205 can be arranged in different planes or directions according to the functionality of the rotator and as is comfortable and intuitive for the hand of the user. The first and second rotator 1203, 1205 can be of different types and associated with different functionalities.

In this disclosure, a rotator should be construed as a rotator means. Thus the term rotator is equivalent to the term rotator means, which can be equivalent to any of the group comprising a scroll wheel, a pressable scroll wheel, a multidirectional joystick, a jog dial, a jog wheel, a track ball, and a disc dial.

For all embodiments it should be noted that the functionalities of the rotators can be any of the ones discussed above, and in any combination and that the rotators can comprise any of the types discussed above, and in any combination, and associated in any feasible way with the functionalities.

The claimed invention has mainly been described above with reference to a few embodiments. However, as is readily appreciated by a person skilled in the art, other embodiments than the ones disclosed above are equally possible within the scope of the invention, as defined by the appended patent claims.

1. A device comprising a first rotator being associated with a first set of functionalities for selection and a second rotator being associated with a second set of functionalities for selection.

2. The device according to claim 1, wherein said second set of functionalities dynamically depends on a selection of said first set of functionalities.

3. The device according to claim 1, wherein selection of said first and second sets of functionalities are independent.

4. The device according to claim 1, wherein said first set of functionalities comprises a set of applications and said second set of functionalities comprises another set of applications.

5. The device according to claim 1, wherein said first and second sets of functionalities comprise a set of applications.

6. The device according to claim 1, being arranged to provide input of a first category relating to said first set of functionalities from said first rotator and to provide input of a second category relating to said second set of functionalities from said second rotator.

7. The device according to claim 1, wherein said first and second rotator are any combination of a group comprising a scroll wheel, a pressable scroll wheel, a multidirectional joystick, a jog dial, a jog wheel, a track ball, and a disc dial.

8. The device according to claim 1, wherein any of said first or second rotator is arranged to be movable in a fixed number of positions, each position being associated with input of an input category.

9. The device according to claim 1, wherein any of said first or second rotator is arranged to provide a rotatable movement around at least one rotation axis, said rotatable movement generating signals associated with input of a category.

10. The device according to claim 1, further comprising at least one other rotator.

11. An apparatus comprising a processor and a user interface, said user interface comprising a display and an input interface, said input interface comprising a first rotator being associated with a first set of functionalities for selection handled by said processor and a second rotator for selection being associated with a second set of functionalities handled by said processor.

12. The apparatus according to claim 11, wherein said second set of functionalities dynamically depends on a selection of said first set of functionalities.

13. The apparatus according to claim 11, wherein selection of said first and second sets of functionalities are independent.

14. The apparatus according to claim 11, wherein said first set of functionalities comprises a set of applications and said second set of functionalities comprises another set of applications.

15. The apparatus according to claim 11, wherein said first and second sets of functionalities comprise a set of applications.

16. The apparatus according to claim 11, wherein said input interface is arranged to provide input of a first category relating to said first set of functionalities from said first rotator and to provide input of a second category relating to said second set of functionalities from said second rotator.

17. The apparatus according to claim 16, wherein said first rotator is adapted for input of said input of the first category, said input being adapted for control of said first set of functionalities.

18. The apparatus according to claim 17, wherein said input are any of the group comprising: menu navigation input, application control input, application select input, and parameter input.

19. The apparatus according to claim 16, wherein said second rotator is adapted for input of said input of the second category, said input being adapted for parameter input relating to said second set of functionalities.

20. The apparatus according to claim 19, wherein said input is any of the group comprising: letters, numerals, special characters, and other symbols.

21. The apparatus according to claim 16, wherein said first set of functionalities is any of the group comprising: menu navigation, application control, application selection, and parameter data input.

22. The apparatus according to claim 16, wherein said second set of functionalities is any of the group comprising: character input, numeral input, letter input, and symbol input.

23. The apparatus according to claim 11, wherein said first and second rotator are any combination of a group comprising a scroll wheel, a pressable scroll wheel, a multidirectional joystick, a jog dial, a jog wheel, a track ball, and a disc dial.

24. The apparatus according to claim 11, wherein any of said first or second rotator is arranged to be movable in a fixed number of positions, each position being associated with input of an input category.

25. The apparatus according to claim 11, wherein any of said first or second rotator is arranged to provide a rotatable movement around at least one rotation axis, said rotatable movement generating signals associated with input of a category.

26. The apparatus according to claim 11, wherein said input interface further comprises at least one other rotator.

27. The apparatus according to claim 11, wherein said apparatus comprises a mobile telephone, a personal digital assistant, a portable media player, a digital camera, a remote control device, a cordless telephone, a game console, a videophone, or any combination thereof.

28. A method comprising:
receiving input from a first rotator associated with a first set of functionalities;
receiving input from a second rotator associated with a second set of functionalities; and
enabling selection of a functionality based on any of said inputs.

29. The method according to claim 28, further comprising generating a first signal associated with said first rotator;
generating a second signal associated with said second rotator; and
transmitting said first and second signals to a processor.

30. The method according to claim 29, further comprising:
determining, in said processor, a first processing action depending on said first signal, said first processing action being associated with said first set of functionalities; and
executing said first processing action in said processor.

31. The method according to claim 30, further comprising:
determining, in said processor, a second processing action depending on said second signal, said second processing action being associated with said second set of functionalities; and
executing said second processing action in said processor.

32. The method according to claim 28, carried out according to an order adapted according to events generated by user interactions and at a present moment received input.

33. The method according to claim 28, further comprising determining said second set of functionalities based on a performed selection of said first set of functionalities.

34. A computer program product comprising instructions for:
receiving input from a first rotator associated with a first set of functionalities;
receiving input from a second rotator associated with a second set of functionalities; and
enabling selection of a functionality based on any of said inputs.

35. The computer product according to claim 34, further comprising instructions for:
generating a first signal associated with said first rotator;
generating a second signal associated with said second rotator; and
transmitting said first and second signals to a processor.

36. The computer product according to claim 35, further comprising instructions for:
determining, in said processor, a first processing action depending on said first signal, said first processing action being associated with said first set of functionalities; and
executing said first processing action in said processor.

37. The computer product according to claim 35, further comprising instructions for:
determining, in said processor, a second processing action depending on said second signal, said second processing action being associated with said second set of functionalities; and
executing said second processing action in said processor.

38. The computer product according to claim 34, wherein said instructions are carried out according to an order adapted according to events generated by user interactions and at a present moment received input.

39. The computer product according to claim 34, further comprising instructions for determining said second set of functionalities based on a performed selection of said first set of functionalities.
